(19) United States
(12) Patent Application Publication
(10) Pub. No.: US 2013/0042771 A1
(43) Pub. Date: Feb. 21, 2013

(54) APPARATUS AND METHOD FOR TREATING PRODUCTS

(71) Applicants: Marten Alkhagen, Molndal (SE); Helena Berndtsson Arvidsson, Goteborg (SE); Niklas Lagergren, Kullavik (SE); Robert Perneborn, Goteborg (SE)

(72) Inventors: Marten Alkhagen, Molndal (SE); Helena Berndtsson Arvidsson, Goteborg (SE); Niklas Lagergren, Kullavik (SE); Robert Perneborn, Goteborg (SE)

(73) Assignee: SCA Hygiene Products AB, Göteborg (SE)

(21) Appl. No.: 13/576,282

(22) PCT Filed: Feb. 8, 2010
(86) PCT No.: PCT/EP2010/051497

§ 371 Date: Oct. 12, 2012

(51) Int. Cl. B41F 19/02

(52) U.S. Cl. 101/23; 101/32

(57) ABSTRACT

An apparatus for treating products continuously fed to the apparatus includes a first roller rotatable around a first rotation axis and a second roller rotatable around a second rotation axis parallel to the first rotation axis. A treatment gap is formed between the first roller and the second roller. The apparatus further includes an adjusting means for in-line adjusting the nominal size of the treatment gap. The adjusting means includes at least one piezoelectric element for shifting the position of the first rotation axis and/or the second rotation axis.

### FIELD OF THE INVENTION

The invention relates to an apparatus for treating products continuously fed to the apparatus with the features of the pre-characterising part of claim 1. Further, the invention relates to a method for operating such an apparatus according to the features of claim 9.

The apparatus for treating products continuously fed to the apparatus comprises a treatment roller rotatable around a first rotation axis and an anvil roller rotatable around a second rotation axis parallel to the first rotation axis, wherein a treatment gap is formed between the treatment roller and the anvil roller.

### PRIOR ART

Apparatus with a treatment gap formed between a treatment roller and an anvil roller are known in the art. Examples of such devices are printing devices or cutting devices as well as any applications in which a substrate to be treated is locally pressed. Examples for such pressing operations are any devices in which products should be brought to a uniform or predetermined thickness, mechanical press bonding, compression or embossing processes treating soft and yieldable products.

In all the above exemplified processes and apparatus, two distinct problems arise. Firstly, products might have a varying thickness in the feeding direction of the products, i.e. the machine direction. Such thickness profile can e.g. in printing operations lead to uneven printing results because the contact pressure of a printing roller onto the substrate to be imprinted is higher in zones of a higher product thickness than in zones of a lower product thickness. A second problem in such treating apparatus is the deflection of the whole treatment unit. This deflection is influenced by the nip contact area between the product and the treatment roller, the elasticity of the unit and the hardness of the product if this property should change within one product. When the nip contact area in an embossing unit increases, there is more material squeezed in the nip between an embossing roll and an anvil roll. Consequently, the force increases which gives rise to a deflection of the unit. Only if the apparatus for treating products was totally stiff without any elasticity, the unit deflection would not occur. However, it is not possible to exclude a certain degree of unit deflection which widens the gap between a treatment roller and an anvil roller.

JP 2004/156931 A describes a device for adjusting a clearance between two rollers presumably used in a printing device. There is a rough adjustment by using a wedge element and, in addition to this, a fine adjustment of the clearance between two rolls is made by means of a piezoelectric actuator.

WO 00/23204 A1 describes a force-transmitting system specifically with reference to its use in cold-or hot-rolling of metal strips. A rough positional adjustment is carried out by means of bias springs and the fine adjustment uses piezo actuators. Signals coming from height sensors can be used in a control system for the electrical actuation of the piezo elements and/or of the hydraulic actuation of the bias springs so that an optimum position of the device can be reached. In this way, vibrations of the metal to be rolled can be effectively dampened.

EP 1 447 204 A1 describes ultrasonic welding using a counter roll, which can be actuated by means of a piezo actuator. In order to perform ultrasonic welding, a counter roll is used for the specific process of ultrasonic welding.

U.S. Pat. No. 6,733,605 B1 discloses an apparatus for dynamically friction bonding plural workpiece layers together with a support roll and an anvil roll. The outer circumferential portions of the support roll and the anvil roll define a nip for receiving corresponding workpiece layers to be bonded together. A linear servo motor apparatus is provided for applying a predetermined force of the rollers toward each other such that the outer circumferential portions of the support roller and the anvil roll bond together predefined portions of workpiece layers passing through the nips. This servo motor apparatus comprises first and second linear servo motors which can be operated such that the force applied to the plural workpiece layers can follow a predefined force profile. Additionally, a sensor may be provided for sensing suitable indicia on the workpiece sections corresponding to a predefined location such as the leading or trailing edge of the workpieces. U.S. Pat. No. 6,733,605 B1 represents the closest prior art.

### DISCLOSURE OF THE INVENTION

It is an object of the invention to provide an apparatus and a method for treating products continuously fed to the apparatus between a first roller and a second roller such that products can be processed with high quality.

This object is solved by an apparatus with the features of claim 1 and a method with the features of claim 9.

According to the invention, an apparatus for treating products continuously fed to the apparatus comprises a first roller rotatable around a first rotation axis and a second roller rotatable around a second rotation axis parallel to the first rotation axis. A treatment gap is formed between the first roller and the second roller. The apparatus is characterized in that it further comprises an adjusting means for in-line adjusting the nominal size of the treatment gap, the adjusting means comprising at least one piezoelectric element for shifting the position of the first rotation axis and/or second rotation axis. The first roller is an embossing roller or compression roller.

Reference to the in-line adjusting of the nominal size of the treatment gap indicates that such gap would change if no product was treated in the gap. When a product is treated, the adjusting operation could lead to the result that the existing treatment gap remains of the same size, because the adjustment only serves to compensate for a change of the size of the gap due to bending forces acting on and play in the apparatus.

An important aspect of the invention is that the adjusting means comprising at least one piezoelectric element is suitable for an in-line adjusting of the nominal size of the treatment gap. Since the products to be treated can be continuously fed to the apparatus, and each individual product might require one or a series of adjustment operations of the adjusting means, repeated or even continuous adjusting operations when using the inventive apparatus are possible.

Another important aspect is the very short response time of piezoelectric elements which makes it possible to run the inventive apparatus with high line speeds. Such short response time can even be achieved under high load or pressure. It is possible to almost make a stepwise change of the gap over the whole adjustment range.

According to a preferred embodiment, the piezoelectric element is attached to one or more bearings guiding a shaft of the first roller or second roller. This specific measure reduces the overall mass to be moved compared to attaching the piezoelectric element to a frame element rotatably holding the first or second roller.

Further it is preferred that the at least one piezoelectric element shifts the second rotation axis, the second roller having a lower weight than the first roller. In many treatment apparatus the second roller could be an anvil roller running against a treatment roller. In comparison to most types of treatment rollers, the anvil rollers have a smaller mass so that the actuation forces necessary to shift the position of the rotation axis of the anvil roller can be kept smaller. Hence, vibration forces generated by the moving mass of the anvil roller can be kept small.

Preferably, the adjusting means is coupled to a control device for operating the adjusting means in a predetermined timely sequence. Such control device is preferably an electronic component having access to a data storage in which, depending on the specific shape of the products to be treated and the conditions of treatment, a sequence of adjusting operations for the treatment gap can be stored. If an electromechanically operated control device is contemplated, a cam element synchronized with the apparatus could be used which is in contact with a plunger element which translates a translational movement into an electric signal to operate the piezoelectric element.

According to a preferred embodiment, the control means is functionally coupled to a sensor for determining at least one characteristic property of the products to be treated or of the apparatus. Such characteristic property could be the thickness of a specific product or of specific parts of the product. In such a way, the sensor could determine the thickness profile of each product and transmit such data to the control device which operates the adjusting means using information provided by the sensor. In such a way, it is possible to treat products, which are not uniformly shaped but could have an individual and varying thickness in the machine direction. The gap between the anvil roll and an embossing roll could then be adjusted such that the embossing operations are controlled in which a uniform embossing depth is achieved by a continuous adjustment of the embossing gap.

A sensor for determining at least one characteristic property of the products to be treated could also be used to determine the exact position of the leading end or trailing end of a product fed to the treatment apparatus. According to a preferred embodiment of the invention, the sensor comprises a line camera system. A sensor may also be used for determining at least one characteristic property of the apparatus, when a product is presently treated. According to another embodiment, the sensor can be a gap sensor or a load cell.

In view of the fact that the stroke of commercially available piezoelectric actuators is relatively small, the inventive apparatus according to a preferred embodiment further comprises a second adjusting means for shifting the position of the first rotation axis or a second rotation axis. In other words, the second adjusting means serves to provide a rough adjustment of the treatment gap, whereas the fine adjustment is carried out by means of the first adjusting means with the piezoelectric actuator. Further, the rough adjusting by means of the second adjusting means is preferably carried out with the treatment roller so that the construction of the anvil roller and its framework can be kept simple and with a low weight.

According to the invention, the first roller being an embossing roller or compression roller also includes its use for achieving press bonding.

The inventive method for operating an inventive apparatus comprises the steps of continuously directing products to be treated into the treatment gap between the rotating first roller and the rotating second roller; transmitting data describing at least one characteristic property of the process to a control unit; and operating the adjusting means for in-line adjusting the size of the treatment gap based on output signals from the control units, so as to vary the size of the treatment gap within each product to be treated. What is meant by a characteristic property of the process could be the position of individual products to be treated, the shape and thickness profile of the individual products or specific information on the treatment itself like line pressure differences or the size of the gap. It is important to note that the size of the treatment gap is varied within each product to be treated and within a continuous process. This is also reflected by the term “in-line adjusting the size of the treatment gap”.

According to a preferred embodiment of the process, the characteristic property of the process is the local contact area between the first roller and the product to be treated. The local contact area describes at any line perpendicular to the machine direction the sum of the contact areas between first roller and second roller on such a geometric locus. This is related to the so-called line pressure and reflects the fact that, the larger the local contact area or line pressure is, the higher are the bending forces acting on the apparatus. The higher the bending forces are, the larger becomes the treatment gap between the rollers, e.g. the treatment roller and the anvil roller. Consequently, a large local contact area needs a higher degree of adjustment in a way to reduce the width of the treatment gap.

Preferably, the method further comprises, before the step of transmitting data, the determining of at least one characteristic property of the individual products to be treated, preferably the thickness profile of the products to be treated. Such method step is carried out by means of a sensor positioned upstream of the apparatus. The sensor determines the at least one characteristic property of the individual products to be treated, and uses such property or a numeric value representing such property for the computing of the correct adjustment of the size of the treatment gap. The control unit could use data from two different sources and compute the degree of gap adjustment based on both given basic information already stored in an electronic storage means and in-line information obtained by means of the sensor arranged upstream of the treatment gap. To give an example, the profile of the core thickness of the products could be stored in an electronic memory means and the position of individual products like the leading end or trailing end of the products could be determined by means of a sensor. The data of both the sensor and the memory means are compiled into an adequate operation of the piezoelectric actuator in order to control the individual starting times and adjustment process for each individual product. Other data which could be fed to the control unit are e.g. the line speed of the apparatus which implies the correct adjusting speed of the piezoelectric apparatus.

The products to be treated are absorbent articles with a varying thickness over the extension in the machine direction. It can be the core of the products that varies in thickness.

### BRIEF DESCRIPTION OF THE DRAWINGS

In the following, the invention will be briefly discussed with reference to the drawings in which:

FIG. 1 schematically shows the inventive apparatus and a product to be treated;

FIG. 2a shows the core profile of an example product to be embossed;

FIG. 2b schematically shows the actuator position of the piezoelectric element according to the core profile as shown in FIG. 2a;

FIG. 2c shows an example embossing pattern on the product as shown in FIG. 2a;

FIG. 2d schematically shows a degree of deflection of the embossing apparatus over the length of the embossing pattern as shown in FIG. 2c;

FIG. 2e shows the actuator position of the piezoelectric element in order to compensate the deflection pattern as shown in FIG. 2d; and

FIG. 2f gives a superposition of the actuator positions as given in FIG. 2b and FIG. 2e.

### DESCRIPTION OF PREFERRED EMBODIMENTS

In the following drawings, the same or similar elements are represented by the same reference numerals.

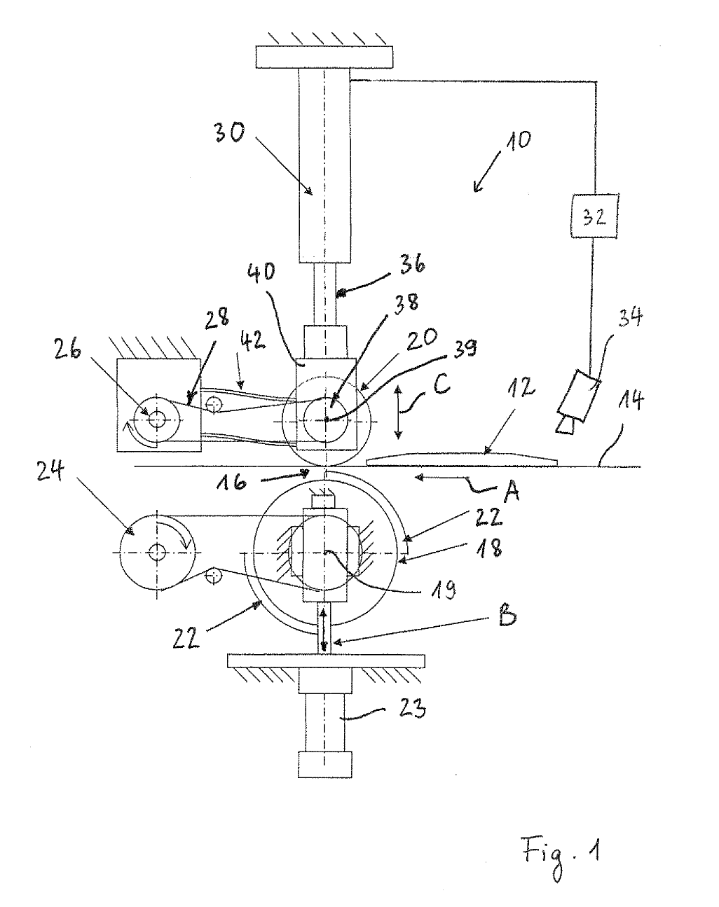

FIG. 1 schematically shows the inventive apparatus for treating products continuously fed to the apparatus 10. Individual products 12 are positioned on a conveying means 14, which can be of any conventional type and which conveys and feeds product 12 through the apparatus.

The products are treated in a gap 16 which is formed between a treatment roller 18 and an anvil roller 20. The treatment roller 18 in the specific example as shown is a pattern roller and there is schematically shown a pattern ridge 22 on the outer circumferential surface of the roller 18. The pattern roller rotates around rotational axis 19 and is driven by a suitable conventional drive 24.

The vertical position of the treatment roller 18 can be roughly adjusted in the directions as indicated by arrows B. Such rough adjustment can be achieved by a pneumatic actuator 23 and the use of distance plates to fix the vertical position of the treatment roller 18.

The anvil roller 20 has a smooth yielding outer circumferential surface. It rotates around rotational axis 39 and is driven by an anvil roller drive 26 which, in the present example, uses a belt drive 28.

The anvil roller 20 can be lowered and lifted in the vertical directions as indicated by arrow C which symbolises the dynamic stroke of the anvil roller. To this end, the anvil roller is attached to a piezo actuator 30 which, at its upper end is mounted at a fixed position as schematically indicated in FIG. 1. The piezo actuator can be of a commercially available type like those available by Piezomechanik GmbH in Germany with a stack of single piezo elements which can provide an overall stroke of about 0.3 mm. Such piezo actuator system shows a linear relationship between the voltage applied and the extension. Due to the linear extension behaviour and the very short response time, a quick and accurate extension of the piezo actuator can be realised. As an example, such piezo actuators have a response time of 8 milliseconds for a stroke of 0.3 mm at a force of at least 5 kN. The piezo actuator is provided with driving signals by a control means 32 which preferably is also provided with a memory device. The control means 32 can additionally process information received from a sensor 34 which, in the schematic drawing of FIG. 1 is exemplified as a line camera system.

The extendable plunger 36 of the actuator 30 is fixedly attached to the rotation shaft 38 of the anvil roller 20. This attachment can be realized in a conventional way, for example by fixing the plunger 36 of the piezo actuator 30 to a bearing element 40 of the rotation shaft 38. In order to account for the up and downward movement of the anvil roller 20 relative to the anvil roller drive 26 which is at a fixed position, the anvil roller drive 26 and the bearing 40 of the anvil roller 20 are connected by means of a plate spring 42 which acts as a hinge.

In the specific example as shown in FIG. 1, one piezo actuator 30 is shown. However, it is also possible to use two or more piezo actuators which could be attached to individual bearings holding the rotation shaft 38 of the anvil roller. If two piezo elements are attached to the rotation shaft, both piezo actuators 30 are spaced apart in a direction perpendicular to the plane of FIG. 1. In such a case it would even be possible to account for products having a core thickness profile which does not only vary in the machine direction A but also in a direction perpendicular to this.

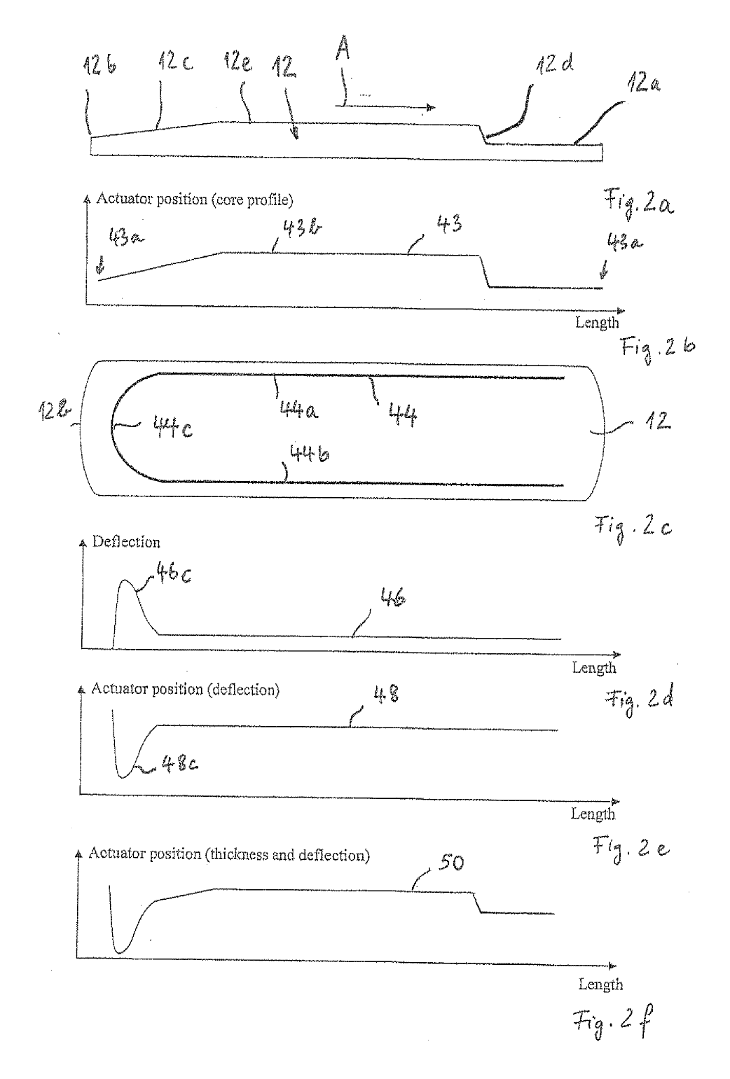

The operation of the device as shown in FIG. 1 will now be explained by means of a specific example as given in FIGS. 2a to 2f.

FIG. 2a shows product 12 and the conveying direction A through the inventive device. As can be seen in FIG. 2a, the core profile in the machine direction A of the product 12 is not constant. The leading end section 12a and the trailing end 12b have a smaller core thickness. Starting from the trailing end the core thickness continuously increases in section 12c and reaches a constant thickness in the middle section 12e. Starting from leading end section 12a with constant thickness, there is a steep increase in core thickness in section 12d reaching middle section 12e with constant core thickness. Section 12c has a slow increase, whereas section 12d is a very sharp increase which is nearly a stepwise change of thickness.

If a constant embossing depth or density is desired, the embossing operation in the device according to FIG. 1 has to account for the core thickness profile. Therefore, as is schematically shown in FIG. 2b, the actuator position of the piezo actuator 30 has to be adjusted over the length of the product. The curve 43 as shown uses the same dimension of length as the core profile as given in FIG. 2a. It shows that the actuator has to be at the lowest position at a position 43a corresponding to the leading end section 12a and the trailing end 12b of product 12, is sharply lifted up in section 12d of the product where the core thickness steeply increases starting from the leading end section 12a, reaches a constant level in section 43b of the actuator position in which the actuator is lifted up to constant height and for the constant core thickness in section 12e of the product and finally is continuously lowered again to reach again position 43a.

FIGS. 2c, 2d and 2e show the second function of the piezo actuator which can be used alternatively or in addition to the function as explained with regard to FIGS. 2a and 2b accounting for a core profile.

FIG. 2c shows product 12 from above and an embossing pattern 44 to be used on the product as shown in FIGS. 2a and 2c. There are two linear embossed depressions 44a and 44b which, close to the trailing end 12b of the product 12 are connected by means of an arc-shaped embossing depression 44c.

In regions 44a and 44b, where the embossing depression is applied in machine direction A (see FIG. 2a), the bending forces acting on the embossing station consisting of the treatment roller and the anvil roller are relatively small. This is exemplified in the schematic diagram of FIG. 2d which gives the relative deflection of the embossing device over the length of the product in machine direction. The length dimension is the same as that used in all FIGS. 2a to 2f, whereas the deflection is just a schematic value which is influenced by many constructional details of the embossing apparatus. However, it can be seen that the deflection curve 46 shows a low deflection in section 44a and 44b, whereas in the arc-shaped region 44c with an embossing pattern which has an increased line pressure in a direction perpendicular to the machine direction, the deflection curve 46 forms a peak 46c. Such deflection has the effect that the gap between the embossing roller and the anvil roller is widened. In order to account for such widening of the gap, the piezoelectric actuator can be operated in order to compensate for this. This is shown in FIG. 2e which schematically shows the actuator position for compensating the deflection over the length of the product in the machine direction. The actuator position curve 48 is a mirror image of the deflection curve 46 because, as outlined above, the deflection leads to a widening of the gap which the actuator position has to compensate. Therefore, in regions where the deflection is highest, the actuator position curve 48 has to be lowest which means that the gap between the embossing roller and anvil roller is closed to the extent in which it is widened by the deflection. This is why in region 48c, the actuator position has to be lowest close to the trailing end of the product.

FIG. 2f shows a combined curve 50 which gives the actuator position accounting for both the thickness profile of the core of the products and the actuator position in order to compensate deflection effects. It should be noted that FIG. 2f simply uses a superposition of schematic actuator position data given in drawings 2b and 2e, both of which in themselves were only schematic. However, when correct actuator positions accounting for a thickness profile of the products and correct actuator positions accounting for deflections effects have been determined and quantified, it is a superposition of the actuator positions of both individual effects which, in combination, lead to a combined actuator position curve 50 as shown in FIG. 2f and which takes into account and corrects both effects.

It can be seen that by means of the piezoelectric actuators having an extremely short response time and the ability to provide for an extremely accurate positioning even under high pressure or load, even products continuously processed and treated with a high conveying speed can be accurately treated leading to a high quality processing of the products.

1. Apparatus for treating products continuously fed to the apparatus (10), comprising:
a first roller (18) rotatable around a first rotation axis (19); and
a second roller (20) rotatable around a second rotation axis (39); wherein
a treatment gap (16) is formed between the first roller (18) and the second roller (20),
characterized in that
the apparatus (10) further comprises:
an adjusting means (30) for in-line adjusting the nominal size of the treatment gap,
the adjusting means comprising at least one piezoelectric element (30) for shifting the position of the first rotation axis (19) and/or the second rotation axis (39).

2. Apparatus according to claim 1,
characterized in that
the piezoelectric element (30) is attached to one or more bearings (40) guiding a shaft (38) of the first (18) or second roller (20).

3. Apparatus according to claim 1 or claim 2
characterized in that
the piezoelectric element (30) shifts the second rotation axis (39), the second roller (20) having a lower weight than the first roller (18).

4. Apparatus according to any of the preceding claims
characterized in that
the first roller is a treatment roller (18), and the second roller is an anvil roller (20).

5. Apparatus according to any of the preceding claims,
characterized in that
the adjusting means (30) is coupled to a control device (32) for operating the adjusting means (30) in a predetermined timely sequence.

6. Apparatus according to claim 5, wherein the control means (32) is functionally coupled to a sensor (34) for determining at least one characteristic property of the products (12) to be treated or of the apparatus.

7. Apparatus according to claim 6, the characteristic property being the thickness of a specific product (12) or of specific parts of the product (12).

8. Apparatus according claim 6 or claim 7, the sensor comprising a line camera system (34).

9. Apparatus according to any of the preceding claims, further comprising a second adjusting means (23) for shifting the position of the first rotation axis (19).

10. Apparatus according to any of the preceding claims,
characterized in that
the first roller is an embossing roller (18) or compression roller.

11. Apparatus according to any of the claims 1 to 9,
characterized in that
the first roller is a cutting roller.

12. Apparatus according to any of claims 1 to 9,
characterized in that
the first roller is a printing roller.

13. Method for operating an apparatus according to any of the preceding claims, comprising the steps:
(a) continuously directing products to be treated into the treatment gap between the rotating first roller and the rotating second roller;
(b) transmitting data describing at least one characteristic property of the process to a control unit;
(c) operating the adjusting means for in-line adjusting the size of the treatment gap based on output signals from the control unit, so as to
(d) vary the size of the treatment gap within each product to be treated by means of at least one piezoelectric actuator.

14. Method according to claim 13, wherein in step (b) the characteristic property is the local contact area between the first roller and the product to be treated.

15. Method according to claim 13, further comprising the step before step (b)
(a1) determining at least one characteristic property of the individual products to be treated, preferably the thickness profile of the products to be treated.

16. Use of a piezoelectric element for shifting the rotation axis of an anvil roller in an apparatus treating continuously fed products between a rotating treatment roller and the anvil roller.
